(19) United States
(12) Patent Application Publication
(10) Pub. No.: US 2022/0042625 A1
(43) Pub. Date: Feb. 10, 2022

(54) Thermoplastic Vulcanizate Compositions in Polymeric Inner / Pressure Sheaths of Flexible Pipes for Oil & Gas Applications

(71) Applicant: ExxonMobil Chemical Patents Inc., Baytown, TX (US)

(72) Inventors: Wanli Wang, Shanghai (CN); Antonios K. Doufas, Houston, TX (US); Krishnan Anantha Narayana lyer, Manvel, TX (US); Krassimir l. Doynov, Houston, TX (US); Deborah J. Davis, League City, TX (US); Andrew A. Takacs, Houston, TX (US); Angela M. Person, Humble, TX (US)

(21) Appl. No.: 17/275,497

(22) PCT Filed: Sep. 9, 2019
(86) PCT No.: PCT/US2019/050125

§ 371 Date: Mar. 11, 2021

Related U.S. Application Data
(60) Provisional application No. 62/731,168, filed on Sep. 14, 2018.

(51) Int. Cl. F16L 11/08; C08L 23/16; C08L 23/22; C08L 23/12; C08L 9/02; C08K 5/00

(52) U.S. Cl. CPC F16L 11/083; C08L 23/16; C08L 23/22; C08L 23/12; C08L 2205/24; C08K 5/0016; C08L 2203/18; C08L 2205/02; C08L 9/02

(57) ABSTRACT

In an embodiment, a flexible pipe is provided. The flexible pipe includes a polymeric inner sheath that includes a thermoplastic vulcanizate (TPV) composition, the TPV composition comprising: a rubber and a thermoplastic olefin, wherein a concentration of the rubber is from 20 wt % to 90 wt % based on a combined weight of the rubber and the thermoplastic olefin, and a concentration of the thermoplastic olefin is from 10 wt % to 80 wt % based on the combined weight of the rubber and the thermoplastic olefin; and wherein the TPV composition has at least one of an air permeability of less than 30 barrers at 23° C. and a CO₂ permeability of less than 40 barrers at 23° C. In another embodiment, a thermoplastic umbilical hose is provided. In another embodiment, a pipe structure is provided.

### PRIORITY

This application claims priority to Provisional Application No. 62/731,168, filed Sep. 14, 2018, the disclosure of which is incorporated herein by reference.

### FIELD

Embodiments of the present disclosure generally relate to thermoplastic vulcanizate compositions, and more particularly, to the use of thermoplastic vulcanizate compositions in polymeric sheaths, particularly inner sheath, in flexible pipes for oil and gas field operations.

### BACKGROUND

Flexible pipes are used to transport fluids between oil and gas reservoirs and platforms for separation of oil, gas and water components. The flexible pipe structures include layers of materials, the layers being, for example, polymeric, metallic, and composite layers.

For fluid containment, conventional flexible pipes include an inner (pressure) sheath which contacts the fluids being transported in the flexible pipe. Because the inner pressure sheath contacts the fluids being transported in the pipe, good resistance to physical and chemical degradation, resistance to hydrolysis, and low permeability to various gases in the fluids transported. Conventionally, polymers for fluid containment for flexible pipes and thermoplastic hoses are nylon PA11 and nylon PA12. However, these nylons and other conventional materials suffer from aging problems under the external environment such as low resistance to physical and chemical degradation and low resistance to hydrolysis. Conventional materials also show poor crack propagation strength, permeability to various gases in the fluids being transferred, limited fatigue strength, high deformability. In addition, commercially available nylon is relatively expensive.

Thermoplastic vulcanizate (TPV) compositions comprise finely-divided rubber particles dispersed within a thermoplastic matrix. These rubber particles are advantageously crosslinked to promote elasticity. The dispersed rubber phase is typically referred to as the discontinuous phase, and the thermoplastic phase is referred to as the continuous phase. Such TPV compositions are well known and may be prepared by dynamic vulcanization, which is a process whereby a rubber is cured or vulcanized using a curative agent within a blend with at least one thermoplastic polymer while the polymers are undergoing mixing or masticating at some elevated temperature, preferably above the melt temperature of the thermoplastic polymer. For example, U.S. Pat. No. 4,130,535 discloses a TPV composition comprising blends of a polyolefin resin and completely cured olefin copolymer rubber. TPV copolymers thus have the benefit of the elastomeric properties provided by the elastomer phase, with the processability of thermoplastics. Conventional TPVs based on polypropylene/ethylene propylene diene monomer rubber (PP/EPDM) have low barrier and low resistance to hydrocarbon fluids. Therefore there is a need for new TPVs that can provide the excellent flexibility of PP/EPDM TPVs while overcoming the deficiencies such as barrier and oil resistance.

References for citing in an Information Disclosure Statement (37 CFR 1.97(h)) include: U.S. Pat. Nos. 6,376,586, 4,130,534; 4,355,139; 4,271,049; 4,299,931; WO2013128097; U.S. Patent Publication No. 2005/022991.

There is a need for an alternative and more robust material for pressure sheaths (i.e., polymeric sheaths) of flexible pipes and thermoplastic hoses for off-shore oil and gas applications.

### SUMMARY

In an embodiment, a flexible pipe is provided. The flexible pipe includes a polymeric inner sheath that includes a thermoplastic vulcanizate (TPV) composition. The TPV composition includes a rubber and a thermoplastic olefin, where a concentration of the rubber is from 20 wt % to 90 wt % based on a combined weight of the rubber and the thermoplastic olefin, and a concentration of the thermoplastic olefin is from 10 wt % to 80 wt % based on the combined weight of the rubber and the thermoplastic olefin. The TPV composition has at least one of an air permeability of less than 30 barrers at 23° C. and a CO₂ permeability of less than barrers at 23° C.

In another embodiment, a thermoplastic hose is provided. The thermoplastic hose includes a polymeric inner sheath that includes a thermoplastic vulcanizate (TPV) composition. The TPV composition includes a rubber and a thermoplastic olefin, where a concentration of the rubber is from 20 wt % to 90 wt % based on a combined weight of the rubber and the thermoplastic olefin, and a concentration of the thermoplastic olefin is from 10 wt % to 80 wt % based on the combined weight of the rubber and the thermoplastic olefin. The TPV composition has at least one of an air permeability of less than 30 barrers at 23° C. and a CO₂ permeability of less than 40 barrers at 23° C.

In another embodiment, a pipe structure is provided. The pipe structure includes any polymeric inner sheath described herein.

Other and further embodiments are described below.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, for the disclosure may admit to other equally effective embodiments.

FIG. 1 shows a side view of a flexible pipe.

FIGS. 2A and 2B show, as bar graphs, fluid stability characteristics of example TPV is compositions according to some embodiments.

FIGS. 3A and 3B show, as bar graphs, fluid stability characteristics of example TPV compositions according to some embodiments.

FIGS. 4A and 4B show, as bar graphs, fluid stability characteristics of example TPV compositions according to some embodiments.

FIGS. 5A and 5B show, as bar graphs, fluid stability characteristics of example TPV compositions according to some embodiments.

### DETAILED DESCRIPTION

Embodiments of the present disclosure relate to the use of TPV compositions in polymeric inner (pressure) sheaths of flexible pipes and in thermoplastic hoses for oil and gas field operations. As noted above, conventional TPVs based on nylons and PP/EPDM show, e.g., at least one of low barrier, resistance to fluids, etc. The inventors have discovered that PP/nitrile rubber and PP/butyl rubber TPVs can overcome many of these deficiencies of Nylon and PP/EPDM based TPVs.

For purposes of this disclosure, the terms “conduit”, “pipe”, “hose”, “tube”, and the like can be used interchangeably.

For purposes of this disclosure, the terms “housing”, “sheath”, “liner” and “layer” can be used interchangeably in the practice of the present invention.

### Polymeric Sheaths

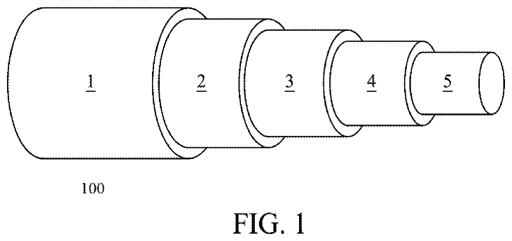

FIG. 1 shows, schematically, a side view of a flexible pipe 6 according to some embodiments. The flexible pipe comprises from inside out an inner (pressure) sheath 5, a first armor layer 4, an intermediate sheath 3, a second armor layer 2, and an outer sheath 1. Inner (pressure) sheath 5 contacts the oil and/or gas. The inner (pressure) sheath 5 is made from a composite material comprising one or more TPV compositions as described below. The first armor layer 4 provides strength to the tube and can be made from, for example, one or more layers of metal and/or reinforced polymer (e.g., carbon nanotube reinforced polyvinylidene fluoride (PVDF)). Intermediate sheath 3 provides thermal insulation and/or anti-wear resistance. Second armor layer 2 provides strength and pressure resistance to the tube and can be made from, for example, one or more layers of metal. Outer sheath 1 protects the pipe structure and has the properties of abrasion resistance and fatigue resistance.

Conventional materials used for polymeric inner (pressure) sheaths for fluid containment (e.g., inner sheath 5 and outer sheath 1) include nylons (polyamides) such as nylon is PA11 and nylon PA12. However, conventional materials, particularly polyamides, suffer from aging problems under the external environment such as low resistance to physical and chemical degradation and low resistance to hydrolysis. Conventional materials also show poor crack propagation strength, limited fatigue strength, high deformability, among other negative characteristics. Conventional TPV materials based on PP/EPDM show low barrier properties to acid gases hence failing to meet the minimum standards for use as a pressure sheath. A certain class of TPVs has been surprisingly found to provide an alternative and more robust material for polymeric inner (pressure) sheaths for fluid containment. The TPVs can also be used for thermoplastic hoses.

In some embodiments, a pipe structure is provided. The pipe structure includes any polymeric inner (e.g., pressure) sheath described herein. In some embodiments, the pipe structure is in accordance with least one of the following standards. API Spec 17J, API Spec 17K, and DNV RP F119.

In some embodiments, a flexible pipe includes a polymeric inner (pressure) sheath having a thickness of from 0.5 mm to 50 mm, such as 1 mm to 20 mm or 5 mm to 15 mm.

In some embodiments, a flexible pipe includes a polymeric inner (pressure) sheath; an inner housing; at least one reinforcing layer at least partially disposed around the inner housing; and an outer protective sheath at least partially disposed around the at least one reinforcing layer.

Disclosed herein is a method for employing the TPV composition in the one or more layers of the inner (pressure) sheath, of a flexible pipe. Use of the inventive TPV composition as the inner (pressure) sheath, of a flexible pipe has various benefits including good resistance to chemical and physical degradation, good resistance to hydrolysis, and low permeability to various gases in the fluids transported.

According to an embodiment, the TPV compositions useful for the polymeric inner (pressure) sheaths, as well as the thermoplastic hoses, advantageously includes a crosslinked/cured rubber phase, a thermoplastic phase, a plasticizer, a filler, and a curative. As described below, the crosslinked rubber phase includes one or more of an ethylene-propylene terpolymer rubber, a nitrile rubber, and a butyl rubber, and the thermoplastic phase (i.e., a thermoplastic olefin) includes one or more of a propylene-based polymer, an ethylene-based polymer, and a butene-1-based polymer.

Certain embodiments of the present disclosure include flexible pipes/conduits comprising polymeric layers sheaths, positioned as inner layers (comprising the TPV composition), intermediate layers, or outer layers of: 1) unbonded or bonded flexible pipes, tubes and hoses similar to those described in API Spec 17J and API Spec 17K, and 2) thermoplastic hoses similar to those described in API 17E, or 3) thermoplastic composite pipes similar to those described in DNV RP F119. In other embodiments, the present thermoplastic vulcanizate composition is used in composite tapes (e.g., carbon fibers, carbon nanotubes or glass fibers embedded in a thermoplastic matrix) used in thermoplastic composite pipes similar to those described in DNV RP F119.

The TPV compositions of the present disclosure may be extruded, compression molded, blow molded, injection molded, and/or laminated into various shapes for use in the flexible conduits of the present disclosure, whether forming a single continuous layer or provided in discontinuous segments. Such shapes may include, but are not limited to, layers (e.g., extruded layers) of various thicknesses, tapes, strips, castings, moldings, and the like for providing an outer protective sheath and/or thermal insulating layer to the conduits described herein. In some embodiments, a TPV composition configured for use as at least a portion of a conduit may have a thickness in the range of from 0.5 millimeters (mm) to 30 mm, encompassing any value and subset therebetween.

Certain embodiments of the present TPV compositions are used to form inner (pressure) sheaths, as well as thermoplastic hoses, made by extrusion and/or co-extrusion, blow molding, injection molding, thermo-forming, elasto-welding, compression molding and 3D printing, pultrusion, and other fabrication techniques. The flexible structures can transport hydrocarbons extracted from an offshore deposit and/or can transport water, heated fluids, and/or chemicals injected into the formation in order to increase the production of hydrocarbons. Certain embodiments of the present TPV compositions are used to form the inner layer of a thermoplastic composite pipe.

While the specification is described in embodiments of the polymeric inner (pressure) sheath, it should be understood that the specification is applicable to thermoplastic hoses, and equivalents of the two.

### Characteristics of the TPV Compositions

In some embodiments, the TPV compositions useful as polymeric inner (pressure) sheaths in flexible pipes and thermoplastic hoses includes one or more of the following characteristics:

1) An amount of a rubber such as EPDM rubber, nitrile rubber, or butyl rubber, that is between about 10 wt % to about 90 wt % (such as between about 20 wt % and about 80 wt %) is based on the total weight of the TPV composition. The rubber phase may be any of EPDM rubber, nitrile rubber, and butyl rubber, or combinations thereof, as described herein. The rubber is in crosslinked form in the composition.

2) An amount of a thermoplastic polyolefin, such as a propylene-based polymer, an ethylene-based polymer, and a butene-1-based polymer, or combinations thereof. In some embodiments, the thermoplastic polyolefin can be any thermoplastic polyolefin described herein. For example, a polypropylene that has an the MFR between about 0.5 g/10 min and about 20 g/10 min (such as between about 0.7 g/10 min and 10 g/10 min, such as between about 0.7 g/10 min and about 5 g/10 min), where the polypropylene includes a homopolymer, random copolymer, or impact copolymer polypropylene, or a combination thereof. In some embodiments, the polypropylene is a high melt strength (HMS) polypropylene such as long chain branched (LCB) homopolymer polypropylene. In other embodiments, the thermoplastic olefin can be a polyethylene or a polybutene.

3) An air permeability (such as determined by ASTM D1434-82, Procedure V, wherein films are tested at 23° C. using a gas pressure of 30-40 psi, wherein 1 barrer=3.35×10⁻¹⁶ (mol·m)/(m²·s·Pa) of about 40 barrers or less, such as about 30 barrers or less, such as about 10 barrers or less, such as about 5 barrers or less, such as about 3 barrers or less, such as about 2 barrers or less.

4) A carbon dioxide (CO₂) permeability of about 40 barrers or less, such as about barrers or less, such as about 10 barrers or less, such as about 5 barrers or less, such as about 3 barrers or less, such as about 2 barrers or less.

5) A methane permeability of about 30 barrers or less, such as about 20 barrers or less, such as about 10 barrers or less, such as about 5 barrers or less, such as about 3 barrers or less.

6) A carbon dioxide (CO₂) permeability of about 40 barrers or less, such as about barrers or less, such as about 10 barrers or less, such as about 5 barrers or less, such as about 3 barrers or less, such as about 2 barrers or less.

7) A percent retained tensile strength (23° C.) when exposed to Fuel A (isooctane) of about 200% or less, such as about 150% or less, such as about 100% or less.

8) A percent retained tensile strength (23° C.) when exposed to toluene of about 200% or less, such as about 150% or less, such as about 100% or less.

9) A percent retained tensile strength (23° C.) when exposed to IRM 903 oil of about 250% or less, such as about 200% or less, such as about 150% or less. IRM 903 oil is an industry reference oil.

10) A percent weight change (23° C.) when exposed to Fuel A of about 50% or less, such as about 25% or less, such as about 10% or less.

11) A percent weight change (23° C.) when exposed to toluene of about 50% or less, such as about 25% or less, such as about 10% or less.

12) A percent weight change (23° C.) when exposed to IRM 903 oil of about 150% or less, such as about 125% or less, such as about 100% or less.

13) A percent retained tensile strength (125° C.) when exposed to diesel for seven (7) days of about 30% or more, such as about 60% or more, such as about 80% or more, such as about 90% or more, such as about 95% or more.

14) A percent retained tensile strength (125° C.) when exposed to seawater for seven (7) days of about 60% or more, such as about 80% or more, such as about 90% or more, such as about 95% or more.

15) A percent retained ultimate elongation (125° C.) when exposed to diesel for seven (7) days of about 30% or more, such as about 40% or more, such as about 50% or more, such as about 70% or more, such as about 80% or more, such as about 90% or more.

16) A percent retained ultimate elongation (125° C.) when exposed to seawater for seven (7) days of about 30% or more, such as about 40% or more, such as about 50% or more, such as about 60% or more, such as about 70% or more, such as about 80% or more, such as about 90% or more.

17) A percent retained ultimate tensile strength (125° C.) when exposed to 1% corrosion inhibitor (1.0% Corexit 7720) for seven (7) days of about 40% or more, such as about 50% or more, such as about 60% or more, such as about 70% or more, such as about 80% or more, such as about 90% or more.

18) A percent retained ultimate tensile strength (125° C.) when exposed to 1% corrosion inhibitor (1.0% Corexit 7720) for fourteen (14) days of about 40% or more, such as about 50% or more, such as about 60% or more, such as about 70% or more, such as about 80% or more, such as about 90% or more.

19) A percent retained ultimate tensile strength (125° C.) when exposed to 1% corrosion inhibitor (1.0% Corexit 7720) for thirty (30) days of about 40% or more, such as about 50% or more, such as about 60% or more, such as about 70% or more, such as about 80% or more, such as about 90% or more.

20) A percent retained ultimate tensile strength (125° C.) when exposed to 1% corrosion inhibitor (1.0% Corexit 7720) for sixty (60) days of about 40% or more, such as about 50% or more, such as about 60% or more, such as about 70% or more, such as about 80% or more, such as about 90% or more.

21) A percent weight change (wt %) in 1% corrosion inhibitor (1.0% Corexit 7720) for seven (7) days of from about −6 to about +8, such as from about −4 to about +6, such as from about −3 to about +4, such as from about −2 to about +3, such as from about −1 to about +2, such as from about −1 to about +1, where a negative number indicates a wt % decrease and a positive number indicates a wt % increase.

22) A percent weight change (wt %) in 1% corrosion inhibitor (1.0% Corexit 7720) for fourteen (14) days of from about −6 to about +8, such as from about −4 to about +6, such as from about −3 to about +4, such as from about −2 to about +3, such as from about −1 to about +2, such as from about −1 to about +1, where a negative number indicates a wt % decrease and a positive number indicates a wt % increase.

23) A percent weight change (wt %) in 1% corrosion inhibitor (1.0% Corexit 7720) for thirty (30) days of from about −6 to about +8, such as from about −4 to about +6, such as from about −3 to about +4, such as from about −2 to about +3, such as from about −1 to about +2, such as from about −1 to about +1, where a negative number indicates a wt % decrease and a positive number indicates a wt % increase.

24) A percent weight change (wt %) in 1% corrosion inhibitor (1.0% Corexit 7720) for sixty (60) days of from about −6 to about +8, such as from about −4 to about +6, such as from about −3 to about +4, such as from about −2 to about +3, such as from about −1 to about +2, such as from about −1 to about +1, where a negative number indicates a wt % decrease and a positive number indicates a wt % increase.

25) A percent retained of the ultimate tensile strength in an aqueous solution of 18% calcium chloride and 14% calcium bromide (125° C., aged 7 days) of about 40% or more, such as about 50% or more, such as about 60% or more, such as about 70% or more, such as about 80% or more, such as about 90% or more, such as about 95% or more.

26) A percent retained of the ultimate tensile strength in an aqueous solution of 18% calcium chloride and 14% calcium bromide (125° C., aged 14 days) of about 40% or more, such as about 50% or more, such as about 60% or more, such as about 70% or more, such as about 80% or more, such as about 90% or more, such as about 95% or more.

27) A percent retained of the ultimate tensile strength in an aqueous solution of 18% calcium chloride and 14% calcium bromide (125° C., aged 30 days) of about 40% or more, such as about 50% or more, such as about 60% or more, such as about 70% or more, such as about 80% or more, such as about 90% or more, such as about 95% or more.

28) A percent retained of the ultimate tensile strength in an aqueous solution of 18% calcium chloride and 14% calcium bromide (125° C., aged 60 days) of about 40% or more, such as about 50% or more, such as about 60% or more, such as about 70% or more, such as about 80% or more, such as about 90% or more, such as about 95% or more.

29) A percent weight change (wt %) in an aqueous solution of 18% calcium chloride and 14% calcium bromide (125° C., aged 7 days) of from about −5 to about +5, such as from about −3 to about +3, such as from about −2 to about +2, such as from about −1 to about +1, where a negative number indicates a wt % decrease and a positive number indicates a wt % increase.

30) A percent weight change (wt %) in an aqueous solution of 18% calcium chloride and 14% calcium bromide (125° C., aged 14 days) of from about −5 to about +5, such as from about −3 to about +3, such as from about −2 to about +2, such as from about −1 to about +1, where a negative number indicates a wt % decrease and a positive number indicates a wt % increase.

31) A percent weight change (wt %) in an aqueous solution of 18% calcium chloride and 14% calcium bromide (125° C., aged 30 days) of from about −5 to about +5, such as from about −3 to about +3, such as from about −2 to about +2, such as from about −1 to about +1, where a negative number indicates a wt % decrease and a positive number indicates a wt % increase.

32) A percent weight change (wt %) in an aqueous solution of 18% calcium chloride and 14% calcium bromide (125° C., aged 60 days) of from about −5 to about +5, such as from about −3 to about +3, such as from about −2 to about +2, such as from about −1 to about +1, where a negative number indicates a wt % decrease and a positive number indicates a wt % increase.

33) A hardness that is in the range of from 60 Shore A to 60 Shore D.

In the above characteristics, tensile strength is measured according to ASTM D412, elongation is measured according to ASTM D412, hardness is measured according to ASTM D2240.

Exemplary, but non-limiting TPV compositions include butyl based rubber TPV those described in U.S. Pat. No. 4,130,534, and nitrile rubber based TPVs described in, e.g., is U.S. Pat. Nos. 4,355,139, 4,271,049, and 4,299,931, each of which are incorporated by reference herein in its entirety.

As discussed below, and according to some embodiments, the TPV compositions useful for polymer inner (pressure) sheaths in flexible pipes includes a crosslinked and/or cured rubber phase, a thermoplastic phase, a plasticizer, a filler, and a curative. The cured rubber phase includes one or more of a nitrile rubber and a butyl rubber, and the thermoplastic phase (i.e., a thermoplastic olefin) includes one or more of a propylene-based polymer, an ethylene-based polymer, and a butene-1-based polymer or combination thereof

### Rubber Phase

The rubbers that may be employed to form the rubber phase include those polymers that are capable of being cured or crosslinked by a phenolic resin or a hydrosilylation curative (e.g., silane-containing curative), a peroxide with a coagent, a moisture cure via silane grafting, or an azide. Reference to a rubber may include mixtures of more than one rubber. Non-limiting examples of rubbers include olefinic elastomeric terpolymers, nitriles, butyl rubbers (such as isobutylene-isoprene rubber (IIR), brominated isobutylene-isoprene rubber (BIIR), and isobutylene paramethyl styrene rubber (BIMSM)), and mixtures thereof. In some embodiments, olefinic elastomeric terpolymers include ethylene-based elastomers such as ethylene-propylene-non-conjugated diene rubbers.

### 1. Ethylene-Propylene Rubber

The term ethylene-propylene rubber refers to rubbery terpolymers polymerized from ethylene, at least one other α-olefin monomer, and at least one diene monomer (for example, an ethylene-propylene-diene terpolymer or an EPDM terpolymer). The α-olefins may include propylene, 1-butene, 1-hexene, 4-methyl-1-pentene, 1-octene, 1-decene, or combinations thereof. In one embodiment, the α-olefins include propylene, 1-hexene, 1-octene or combinations thereof. The diene monomers may include 5-ethylidene-2-norbornene; 5-vinyl-2-norbornene: divinylbenzene; 1,4-hexadiene: 5-methylene-2-norbornene; 1,6-octadiene; 5-methyl-1,4-hexadiene: 3,7-dimethyl-1,6-octadiene: 1,3-cyclopentadiene; 1,4-cyclohexadiene; dicyclopentadiene; or a combination thereof. Polymers prepared from ethylene, α-olefin, and diene monomers may be referred to as a terpolymer or even a tetrapolymer in the event that multiple α-olefins or dienes are used.

In some embodiments, where the diene includes 5-ethylidene-2-norbornene (ENB) or 5-vinyl-2-norbornene (VNB), the ethylene-propylene rubber may include at least about 1 wt % (such as at least about 3 wt %, such as at least about 4 wt %, such as at least about 5 wt %) based on the total weight of the ethylene-propylene rubber. In other embodiments, where the diene includes ENB or VNB, the ethylene-propylene rubber may include from about 1 wt % to about 15 wt % (such as from about 3 wt % to about 15 wt %, such as from about 5 wt % to about 12 wt %, such as from about 7 wt % to about 11 wt %) from 5-ethylidene-2-norbornene based on the total weight of the ethylene-propylene rubber.

Unless otherwise indicated, the distribution and the moments of molecular weight (Mw, Mn, Mw/Mn, etc.), the comonomer content (C₂, C₃, C₆, etc.) and the branching index (g′ᵥᵢₛ) are determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10-μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1 μm Teflon filter and degassed with an online degasser before entering the GPC instrument. The nominal flow rate is 1.0 ml/min and the nominal injection volume is 200 μL The whole system including transfer lines, columns, and detectors are contained in an oven maintained at 145° C. The polymer sample is weighed and sealed in a standard vial with 80 μL flow marker (Heptane) added to it. After loading the vial in the autosampler, polymer is automatically dissolved in the instrument with 8 ml added TCB solvent. The polymer is dissolved at 160° C. with continuous shaking for about 1 hour for most PE samples or 2 hour for PP samples. The TCB densities used in concentration calculation are 1.463 g/ml at room temperature and 1.284 g/ml at 145° C. The sample solution concentration is from 0.2 to 2.0 mg/ml, with lower concentrations being used for higher molecular weight samples. The concentration (c), at each point in the chromatogram is calculated from the baseline-subtracted IR5 broadband signal intensity (I), using the following equation: c=βI, where β is the mass constant. The mass recovery is calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10M gm/mole. The MW at each elution volume is calculated with following equation:

$$log M = \frac{log ( {K}_{PS} / K )}{a + 1} + \frac{{a}_{PS} + 1}{α + 1} log {M}_{PS} ,$$

where the variables with subscript “PS” stand or polystyrene while those without a subscript is are for the test samples. In this method, αPS=0.67 and KPS=0.000175 while α and K are for other materials as calculated and published in literature (Sun, T. et al., Macromolecules, 2001, 34, 6812), except that for purposes of the present disclosure, α=0.695 and K=0.000579 for linear ethylene polymers, α=0.705 and K=0.0002288 for linear propylene polymers, α=0.695 and K=0.000181 for linear butene polymers, α is 0.695 and K is 0.000579*(1−0.0087*w2b+0.000018*(w2b)\hat{ }2) for ethylene-butene copolymer where w2b is a bulk weight percent of butene comonomer, α is 0.695 and K is 0.000579*(1−0.0075*w2b) for ethylene-hexene copolymer where w2b is a bulk weight percent of hexene comonomer, and α is 0.695 and K is 0.000579*(1−0.0077*w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dL/g unless otherwise noted.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.):

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and K_{O} is the optical constant for the system:

$${K}_{o} = \frac{4 {π}^{2} {{n}^{2} ( dn / dc )}^{2}}{{λ}^{4} {N}_{A}} ,$$

where N_{A} is Avogadro's number, and (dn/dc) is the refractive index increment for the system. The refractive index, n=1.500 for TCB at 145° C. and λ=665 nm. For analyzing polyethylene homopolymers, ethylene-hexene copolymers, and ethylene-octene copolymers, dn/dc=0.1048 ml/mg and A₂=0.0015; for analyzing ethylene-butene copolymers, dn/dc=0.1048*(1-0.00126*w2) ml/mg and A₂=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across is the detector, and the other, positioned between the two sides of the bridge, measures a differential pressure. The specific viscosity, η_{S}, for the solution flowing through the viscometer is calculated from their outputs. The intrinsic viscosity, [η], at each point in the chromatogram is calculated from the equation [η]=η_{S}/c, where c is concentration and is determined from the IR5 broadband channel output. The viscosity MW at each point is calculated as

M=K_{PS}M^{α}^{_{PS}}⁺¹/[η],

where αₚₛ is 0.67 and Kₚₛ is 0.000175.

The branching index (g′ᵥᵢₛ) is calculated using the output of the GPC-IR5-LS-VIS method as follows. The average intrinsic viscosity, [η]_{avg}, of the sample is calculated by:

$${⌈ η ⌉}_{avg} = \frac{\sum {{c}_{i} [ η ]}_{i}}{Σ {c}_{i}} ,$$

where the summations are over the chromatographic slices, i, between the integration limits.

The branching index g′ᵥᵢₛ is defined as:

$${g}_{vis}^{′} = \frac{{⌈ η ⌉}_{avg}}{K {M}_{ν}^{α}} ,$$

where M_{V} is the viscosity-average molecular weight based on molecular weights determined by LS analysis and the K and α are for the reference linear polymer, which are, for purposes of the present disclosure, α=0.700 and K=0.0003931 for ethylene, propylene, diene monomer copolymers, α=0.695 and K=0.000579 for linear ethylene polymers, α=0.705 and K=0.0002288 for linear propylene polymers, α=0.695 and K=0.000181 for linear butene polymers, α is 0.695 and K is 0.000579*(1−0.0087*w2b+0.000018*(w2b)\hat{ }2) for ethylene-butene copolymer where w2b is a bulk weight percent of butene comonomer, α is 0.695 and K is 0.000579*(1−0.0075*w2b) for ethylene-hexene copolymer where w2b is a bulk weight percent of hexene comonomer, and α is 0.695 and K is 0.000579*(1−0.0077*w2b) for ethylene-octene copolymer where w2b is a bulk weight percent of octene comonomer. Concentrations are expressed in g/cm³, molecular weight is expressed in g/mole, and intrinsic viscosity (hence K in the Mark-Houwink equation) is expressed in dL/g unless otherwise noted. Calculation of the w2b values is as discussed above.

Experimental and analysis details not described above, including how the detectors are calibrated and how to calculate the composition dependence of Mark-Houwink parameters and the second-virial coefficient, are described by T. Sun, P. Brant, R. R. Chance, and W. W. Graessley (Macromolecules, 2001, Vol. 34(19), pp. 6812-6820).

In some embodiments, the ethylene-propylene rubber includes one or more of the following characteristics:

1) An ethylene-derived content that is from about 10 wt % to about 99.9 wt %, (such as from about 10 wt % to about 90 wt %, such as from 12 wt % to about 90 wt %, such as from about 15 wt % to about 90 wt % such as from about 20 wt % to about 80 wt %, such as from about 40 wt % to about 70 wt %, such as from about 50 wt % to about 70 wt %, such as from about 55 wt % to about 65 wt/6, such as from about 60 wt % and about 65 wt %) based on the total weight of the ethylene-propylene rubber. In some embodiments, the ethylene-derived content is from about 40 wt % to about 85 wt %, such as from about 40 wt % to about 85 wt %, based on the total weight of the ethylene-propylene rubber.

2) A diene-derived content that is from about 0.1 to about to about 15 wt %, such as from about 0.1 wt % to about 5 wt %, such as from about 0.2 wt % to about 10 wt %, such as from about 2 wt % to about 8 wt %, or from about 4 wt % to about 12 wt %, such as from about 4 wt % to about 9 wt %) based on the total weight of the ethylene-propylene rubber. In some embodiments, the diene-derived content is from about 3 wt % to about 15 wt % based on the total weight of the ethylene-propylene rubber.

3) The balance of the ethylene-propylene rubber including α-olefin-derived content (e.g., C₂ to C₄₀, such as C₃ to C₂₀, such as C₃ to C₁₀ olefins, such as propylene).

4) A weight average molecular weight (Mw) that is about 100.000 g/mol or more (such as about 200,000 g/mol or more, such as about 400,000 g/mol or more, such as about 600,000 g/mol or more). In these or other embodiments, the Mw is about 1,200,000 g/mol or less (such as about 1,000,000 g/mol or less, such as about 900,000 g/mol or less, such as about 800,000 g/mol or less). In these or other embodiments, the Mw can be between about 500,000 g/mol and about 3,000,000 g/mol (such as between about 500,000 g/mol and about 2,000,000, such as between about 500,000 g/mol and about 1,500,000 g/mol, such as between about 600,000 g/mol and about 1.200,000 g/mol, such as between about 600,000 g/mol and about 1,000,000 g/mol).

5) A number average molecular weight (Mn) that is about 20,000 g/mol or more (such as about 60,000 g/mol or more, such as about 100,000 g/mol or more, such as about 150,000 g/mol or more). In these or other embodiments, the Mn is less than about 500,000 g/mol (such as about 400,000 g/mol or less, such as about 300,000 g/mol or less, such as about 250.000 g/mol or less).

6) A Z-average molecular weight (Mz) that is between about 10,000 g/mol and about 7,000,000 g/mol (such as between about 50,000 g/mol and about 3,000,000 g/mol, such as between about 70,000 g/mol and about 2,000,000 g/mol, such as between about 75,000 g/mol and about 1,500,000 g/mol, such as between about 80.000 g/mol and about 700,000 g/mol, such as between about 100,000 g/mol and about 500,000 g/mol).

7) A polydispersity index (Mw/Mn; PDI) that is between about 1 and about 10 (such as between about 1 and about 5, such as between about 1 and about 4, such as between about 2 and about 4 or between about 1 and about 3, such as between about 1.8 and about 3 or between about 1 and about 2, or between about 1 and 2.5).

8) A dry Mooney viscosity (ML₍₁₊₄₎ at 125° C.) per ASTM D-1646, that is from about MU to about 500 MU or from about 50 MU to about 450 MU. In these or other embodiments, the Mooney viscosity is 250 MU or more, such as 350 MU or more.

9) A glass transition temperature (T_{g}), as determined by Differential Scanning Calorimetry (DSC) according to ASTM E 1356, that is about −20° C. or less (such as about −30° C. or less, such as about −50° C. or less). In some embodiments, T_{g} is between about −20° C. and about −60° C.

The ethylene-propylene rubber may be manufactured or synthesized by using a variety of techniques. For example, these terpolymers can be synthesized by employing solution, slurry, or gas phase polymerization techniques of combination thereof that employ various catalyst systems including Ziegler-Natta systems including vanadium catalysts and take place in various phases such as solution, slurry, or gas phase. Exemplary catalysts include single-site catalysts including constrained geometry catalysts involving Group IV-VI metallocenes. In some embodiments, the EPDMs can be produced via a conventional Zeigler-Natta catalyst using a slurry process, especially those including Vanadium compounds, as disclosed in U.S. Pat. No. 5,783,645, as well as metallocene catalysts, which are also disclosed in U.S. Pat. No. 5,756,416. Other catalysts systems such as the Brookhart catalyst system may also be employed. Optionally, such EPDMs can be prepared using the above catalyst systems in a solution process.

Elastomeric terpolymers are commercially available under the tradenames Vistaloni™ (ExxonMobil Chemical Co.; Houston, Tex.), Keltan™ (Arlanxeo Performance Elastomers; Orange, Tex.), Nordel™ IP (Dow), NORDEL MG™ (Dow), Royalene™ (Lion Elastomers), and Suprene™ (SK Global Chemical). Specific examples include Vistalon 3666, Keltan 5469 Q, Keltan 4969 Q, Keltan 5469 C, and Keltan 4869 C, Royalene 694, Royalene 677, Suprene 512F, Nordel 6555.

In some embodiments, the ethylene-based elastomer may be obtained in an oil extended form, with about a 50 phr to about 200 phr process oil, such as about 75 phr to about 120 phr process oil on the basis of 100 phr of elastomer.

### 2. Nitrile Rubber

Suitable nitrile rubbers comprise rubbery polymers of 1,3-butadiene or isoprene and acrylonitrile. Exemplary nitrile rubbers include polymers of 1,3-butadiene and about 20-50 weight percent acrylonitrile.

In some embodiments, the nitrile rubber includes one or more of the following characteristics:

1) An acrylonitrile-derived content that is about 20 wt % or more (such as from about 20 wt % to about 50 wt %, 25 wt % to about 45 wt %, such as from 30 wt % to about 40 wt %, such as from about 35 wt % to about 40 wt %) based on the total weight of the nitrile rubber.

2) Where the nitrile rubber is a copolymer of isoprene and acrylonitrile, an isoprene-derived content that is from about 10 wt % to about 99.9 wt %, (such as from about 10 wt % to about 90 wt %, such as from 12 wt % to about 90 wt %, such as from about 15 wt % to about 90 wt % such as from about 20 wt % to about 80 wt %/o, such as from about 40 wt % to about 70 wt %, such as from about 50 wt % to about 70 wt %, such as from about 55 wt % to about 65 wt %, such as from about 60 wt % and about 65 wt %) based on the total weight of the ethylene-propylene rubber. In some embodiments, the ethylene-derived content is from about 40 wt % to about 85 wt/o, such as from about 40 wt % to about 85 wt %, based on the total weight of the composition.

3) Where the nitrile rubber is a copolymer of 1,3-butadiene and acrylonitrile, a 1,3-butadiene-derived content that is from about 10 wt % to about 99.9 wt %, (such as from about 10 wt % to about 90 wt %, such as from 12 wt % to about 90 wt %, such as from about 15 wt % to about 90 wt % such as from about 20 wt % to about 80 wt %, such as from about 40 wt % to about 70 wt %, such as from about 50 wt % to about 70 wt %, such as from about 55 wt % to about 65 wt %, such as from about 60 wt % and about 65 wt %) based on the total weight of the ethylene-propylene rubber. In some embodiments, the ethylene-derived content is from about 40 wt % to about 85 wt %, such as from about 40 wt % to about 85 wt %, based on the total weight of the composition.

4) A weight average molecular weight (Mw) that is about 100,000 g/mol or more (such as about 200,000 g/mol or more, such as about 400,000 g/mol or more, such as about is 600,000 g/mol or more). In these or other embodiments, the Mw is about 1,200,000 g/mol or less (such as about 1,000,000 g/mol or less, such as about 900,000 g/mol or less, such as about 800,000 g/mol or less). In these or other embodiments, the Mw can be between about 500,000 g/mol and about 3,000,000 g/mol (such as between about 500,000 g/mol and about 2,000,000, such as between about 500,000 g/mol and about 1,500,000 g/mol, such as between about 600,000 g/mol and about 1,200,000 g/mol, such as between about 600,000 g/mol and about 1,000,000 g/mol). The molecular weight of nitrile based rubbers can be measured via Size Exclusion Chromatography (SEC) or Gel Permeation Chromatography according to the procedure described in “Determining the Mark-Houwink parameters of nitrile rubber: a chromatographic investigation of the NBR microstructure”, C. J. Durr et al., Polym. Chem., 2013, Vol. 4, pp. 4755-4767.

Nitrile rubber can be obtained from a number of commercial sources as disclosed in the Rubber World Blue Book.

A functionalized nitrile rubber containing one or more graft forming functional groups may be used for preparing block copolymer compatibilizers of the present disclosure. The aforesaid “graft forming functional groups” are different from and are in addition to the olefinic and cyano groups normally present in nitrile rubber. Carboxylic-modified nitrile rubbers containing carboxy groups and amine-modified nitrile rubbers containing amino groups are also useful for the TPV compositions described herein.

### 3. Butyl Rubber

In some embodiments, butyl rubber includes copolymers and terpolymers of isobutylene and at least one other comonomer. Useful comonomers include isoprene, divinyl aromatic monomers, alkyl substituted vinyl aromatic monomers, and mixtures thereof. Exemplary divinyl aromatic monomers include vinylstyrene. Exemplary alkyl substituted vinyl aromatic monomers include α-methylstyrene and paramethylstyrene. These copolymers and terpolymers may also be halogenated such as in the case of chlorinated and brominated butyl rubber. In some embodiments, these halogenated polymers may derive from monomer such as parabromomethylstyrene.

In some embodiments, butyl rubber includes copolymers of isobutylene and isoprene, and copolymers of isobutylene and paramethyl styrene, terpolymers of isobutylene, isoprene, and vinylstyrene, branched butyl rubber, and brominated copolymers of isobutene and paramethylstyrene (yielding copolymers with parabromomethylstyrenyl mer units). These copolymers and terpolymers may be halogenated. Exemplary butyl rubbers include isobutylene-isoprene rubber (IIR), brominated isobutylene-isoprene rubber (BIIR), and isobutylene paramethyl styrene rubber (BIMSM).

In some embodiments, the butyl rubber includes one or more of the following characteristics:

1) Where butyl rubber includes the isobutylene-isoprene rubber, the rubber may include isoprene from about 0.5 wt % to about 30 wt % (such as from about 0.8 wt % to about 5 wt %) based on the entire weight of the rubber with the remainder being isobutylene.

2) Where butyl rubber includes isobutylene-paramethylstyrene rubber, the rubber may include paramethylstyrene from about 0.5 wt % to about 25 wt % (such as from about 2 wt % to about 20 wt %) based on the entire weight of the rubber with the remainder being isobutylene.

3) Where the isobutylene-paramethylstyrene rubbers are halogenated, such as with bromine, these halogenated rubbers can contain a percent by weight halogenation of from about 0 wt % to about 10 wt % (such as from about 0.3 wt % to about 7 wt %) based on the entire weight of the rubber with the remainder being isobutylene.

4) Where the isobutylene-isoprene rubbers are halogenated, such as with bromine, these halogenated rubbers can contain a percent by weight halogenation of from about 0 wt % to about 10 wt % (such as from about 0.3 wt % to about 7 wt %) based on the entire weight of the rubber with the remainder being isobutylene.

5) Where butyl rubber includes isobutylene-isoprene-divinylbenzene, the rubber may include isobutylene from about 95 wt % to about 99 wt % (such as from about 96 wt % to about 98.5 wt %) based on the entire weight of the rubber, and isoprene from about 0.5 wt % to about 5 wt % (such as from about 0.8 wt % to about 2.5 wt %) based on the entire weight of the rubber, with the balance being divinylbenzene.

6) Where the butyl rubber includes halogenated butyl rubbers, the butyl rubber may include from about 0.1 wt % to about 10 wt % halogen (such as from about 0.3 wt % to about 7 wt %, such as from about 0.5 wt % to about 3 wt %) based upon the entire weight of the rubber.

7) A glass transition temperature (T_{g}) that is about −55° C. or less (such as about −58° C. or less, such as about −60° C. or less, such as about −63° C. or less).

8) A weight average molecular weight (Mw) that is about 100,000 g/mol or more (such as about 200,000 g/mol or more, such as about 400,000 g/mol or more, such as about 600,000 g/mol or more). In these or other embodiments, the Mw is about 1.200,000 g/mol or less (such as about 1,000,000 g/mol or less, such as about 900,000 g/mol or less, such as about is 800,000 g/mol or less). In these or other embodiments, the Mw can be between about 500,000 g/mol and about 3,000,000 g/mol (such as between about 500,000 g/mol and about 2,000.000, such as between about 500,000 g/mol and about 1,500.000 g/mol, such as between about 600,000 g/mol and about 1,200,000 g/mol, such as between about 600,000 g/mol and about 1,000,000 g/mol). The molecular weight of butyl based rubbers can be measured via Size Exclusion Chromatography (SEC) or Gel Permeation Chromatography according to the procedure described in “GPC Calibration for the Molecular Weight Measurement of Butyl Rubbers”, Judit E. Puskas and Rob Hutchinson, Rubber Chemistry and Technology: November 1993, Vol. 66, No. 5, pp. 742-748.

Butyl rubber can be obtained from a number of commercial sources as disclosed in the Rubber World Blue Book. For example, both halogenated and un-halogenated rubbers/copolymers of isobutylene and isoprene are available under the tradename Exxon Butyl™ (ExxonMobil Chemical Co.), halogenated and un-halogenated copolymers of isobutylene and paramethylstyrene are available under the tradename EXXPRO™ (ExxonMobil Chemical Co.), star branched butyl rubbers are available under the tradename STAR BRANCHED BUTYL™ (ExxonMobil Chemical Co.), and copolymers containing parabromomethylstyrenyl mer units are available under the tradename EXXPRO 3745 (ExxonMobil Chemical Co.). Halogenated and non-halogenated terpolymers of isobutylene, isoprene, and divinylstyrene are available under the tradename Polysar Butyl™ (Lanxess; Germany).

In some embodiments, the rubber (e.g., ethylene-propylene rubber, nitrile rubber, and butyl rubber) can be highly cured. In some embodiments, the rubber is advantageously partially or fully (completely) cured. The degree of cure can be measured by determining the amount of rubber that is extractable from the TPV composition by using cyclohexane or boiling xylene as an extractant. This method is disclosed in U.S. Pat. No. 4,311,628, which is incorporated herein by reference for purposes of U.S. patent practice. In some embodiments, the rubber has a degree of cure where not more than about 5.9 wt %, such as not more than about 5 wt %, such as not more than about 4 wt %, such as not more than about 3 wt % is extractable by cyclohexane at 23° C. as described in U.S. Pat. Nos. 5,100,947 and 5,157,081, which are incorporated herein by reference for purpose of U.S. patent practice. In these or other embodiments, the rubber is cured to an extent where greater than about 94 wt %, such as greater than about 95 wt %, such as greater than about 96 wt %, such as greater than about is 97 wt % by weight of the rubber is insoluble in cyclohexane at 23° C. Alternately, in some embodiments, the rubber has a degree of cure such that the crosslink density is at least 4×10⁻⁵ moles per milliliter of rubber, such as at least 7×10⁻⁵ moles per milliliter of rubber, such as at least 10×10⁻⁵ moles per milliliter of rubber. See also “Crosslink Densities and Phase Morphologies in Dynamically Vulcanized TPEs,” by Ellul et al., RUBBER CHEMISTRY AND TECHNOLOGY, Vol. 68, pp. 573-584 (1995).

Despite the fact that the rubber may be partially or fully cured, the compositions of this disclosure can be processed and reprocessed by conventional plastic processing techniques such as extrusion, injection molding, blow molding, and compression molding. The rubber within these thermoplastic elastomers can be in the form of finely-divided and well-dispersed particles of vulcanized or cured rubber within a continuous thermoplastic phase or matrix. In some embodiments, a co-continuous morphology or a phase inversion can be achieved. In those embodiments where the cured rubber is in the form of finely-divided and well-dispersed particles within the thermoplastic medium, the rubber particles can have an average diameter that is about 50 μm or less (such as about 30 μm or less, such as about 10 μm or less, such as about 5 μm or less, such as about 1 μm or less). In some embodiments, at least about 50%, such as about 60%, such as about 75% of the particles have an average diameter of about 5 μm or less, such as about 2 μm or less, such as about 1 μm or less.

### Thermoplastic Phase

In some embodiments, the thermoplastic phase of the TPV compositions useful in inner (pressure) polymeric sheaths of flexible pipes and thermoplastic hoses includes a polymer that can flow above its melting temperature. In some embodiments, the major component of the thermoplastic phase includes at least one thermoplastic olefin such as a polypropylene (such as a homopolymer, random copolymer, or impact copolymer, or combination thereof), a polyethylene, or a polybutene. In some embodiments, the thermoplastic phase may also include, as a minor constituent, an ethylene-based polymer (e.g., polyethylene) or a propylene-based polymer (e.g., polypropylene), or a butene-1-based polymer (e.g., polybutene and polybutene-1).

### 1. Propylene-Based Polymer

Propylene-based polymers include those solid, generally high-molecular weight plastic resins that primarily comprise units deriving from the polymerization of propylene. In some embodiments, at least 75%, in other embodiments at least 90%, in other embodiments at least 95%, and in other embodiments at least 97% of the units of the propylene-based polymer derive from the polymerization of propylene. In particular embodiments, these polymers include homopolymers of propylene. Homopolymer polypropylene can comprise linear chains and/or chains with long chain branching.

In some embodiments, the propylene-based polymers may also include units deriving from the polymerization of ethylene and/or α-olefins such as 1-butene, 1-hexene, 1-octene, 2-methyl-1-propene, 3-methyl-1-pentene, 4-methyl-1-pentene, 5-methyl-1-hexene, and mixtures thereof. Specifically included are the reactor, impact, and random copolymers of propylene with ethylene or the higher α-olefins, described above, or with C₁₀-C₂₀ olefins.

In some embodiments, the propylene-based polymer includes one or more of the following characteristics:

1) The propylene-based polymers may include semi-crystalline polymers. In some embodiments, these polymers may be characterized by a crystallinity of at least 25 wt % or more (such as about 55 wt % or more, such as about 65 wt % or more, such as about 70 wt % or more). Crystallinity may be determined by dividing the heat of fusion (Hf) of a sample by the heat of fusion of a 100% crystalline polymer, which is assumed to be 209 joules/gram for polypropylene.

2) A Hf that is about 52.3 J/g or more (such as about 100 J/g or more, such as about 125 J/g or more, such as about 140 J/g or more).

3) A weight average molecular weight (Mw) that is between about 50,000 g/mol and about 2,000,000 g/mol (such as between about 100,000 g/mol and about 1,000,000 g/mol, such as between about 100,000 g/mol and about 600,000 g/mol or between about 400,000 g/mol and about 800,000 g/mol) as measured by GPC with polystyrene standards.

4) A number average molecular weight (Mn) that is between about 25,000 g/mol and about 1,000.000 g/mol (such as between about 50,000 g/mol and about 300,000 g/mol) as measured by GPC with polystyrene standards.

5) A g′ᵥᵢₛ that is 1 or less (such as 0.9 or less, such as 0.8 or less, such as 0.6 or less, such as 0.5 or less).

6) A melt mass flow rate (MFR) (ASTM D1238, 2.16 kg weight @ 230° C.) that is about 0.1 g/10 min or more (such as about 0.2 g/10 min or more, such as about 0.2 g/10 min or more). Alternately, the MFR is between about 0.1 g/10 min and about 50 g/10 min, such as between about 0.5 g/10 min and about 5 g/10 min, such as between about 0.5 g/10 min and about 3 g/10 min.

7) A melt temperature (Tₘ) that is from about 110° C. to about 170° C. (such as from about 140° C. to about 168° C., such as from about 160° C. to about 165° C.).

8) A glass transition temperature (T_{g}) that is from about −50° C. to about 10° C. (such as from about −30° C. to about 5° C., such as from about −20° C. to about 2° C.).

9) A crystallization temperature (Tₘ) that is about 75° C. or more (such as about 95° C. or more, such as about 100° C. or more, such as about 105° C. or more (such as between about 105° C. and about 130° C.).

In some embodiments, the propylene-based polymers include a homopolymer of a high-crystallinity isotactic or syndiotactic polypropylene. This polypropylene can have a density of from about 0.89 to about 0.91 g/ml, with the largely isotactic polypropylene having a density of from about 0.90 to about 0.91 g/ml. Also, high and ultra-high molecular weight polypropylene that has a fractional melt flow rate can be employed. In some embodiments, polypropylene resins may be characterized by a MFR (ASTM D-1238; 2.16 kg @ 230° C.) that is about 10 dg/min or less (such as about 1.0 dg/min or less, such as about 0.5 dg/min or less).

In some embodiments, the polypropylene includes a homopolymer, random copolymer, or impact copolymer polypropylene or combination thereof. In some embodiments, the polypropylene is a high melt strength (HMS) long chain branched (LCB) homopolymer polypropylene.

The propylene-based polymers may be synthesized by using an appropriate polymerization technique known in the art such as the conventional Ziegler-Natta type polymerizations, and catalysis employing single-site organometallic catalysts including metallocene catalysts.

Examples of polypropylene useful for the TPV compositions described herein include ExxonMobil™ PP5341 (available from ExxonMobil); Achieve™ PP6282NEI (available from ExxonMobil) and/or polypropylene resins with broad molecular weight distribution as described in U.S. Pat. Nos. 9,453,093 and 9,464,178; and other polypropylene resins described in US20180016414 and US20180051160; Waymax MFX6 (available from Japan Polypropylene Corp.); Borealis Daployr™ WB140 (available from Borealis AG); and Braskem Ampleo 1025MA and Braskem Ampleo 1020GA (available from Braskem Ampleo).

### 2. Ethylene-Based Polymer

Ethylene-based polymers include those solid, generally high-molecular weight plastic resins that primarily comprise units deriving from the polymerization of ethylene. In some embodiments, at least 90%, in other embodiments at least 95%, and in other embodiments at least 99% of the units of the ethylene-based polymer derive from the polymerization of ethylene. In particular embodiments, these polymers include homopolymers of ethylene.

In some embodiments, the ethylene-based polymers may also include units deriving from the polymerization of α-olefins such as propylene, 1-butene, 1-hexene, 1-octene, 2-methyl-1-propene, 3-methyl-1-pentene, 4-methyl-1-pentene, 5-methyl-1-hexene, and mixtures thereof.

In some embodiments, the ethylene-based polymer includes one or more of the following characteristics:

1) A melt index (MI) (ASTM D-1238, 2.16 kg@190° C.) that is from about 0.1 dg/min to about 1,000 dg/min (such as from about 1.0 dg/min to about 200 dg/min, such as from about 7.0 dg/min to about 20.0 dg/min).

2) A melt temperature (Tₘ) that is from about 140° C. to about 90° C. (such as from about 135° C. to about 125° C., such as from about 130° C. to about 120° C.).

The ethylene-based polymers may be synthesized by using an appropriate polymerization technique known in the art such as the conventional Ziegler-Natta type polymerizations, and catalysis employing single-site organometallic catalysts including metallocene catalysts. Ethylene-based polymers are commercially available. For example, polyethylene is commercially available under the tradename ExxonMobil™ Polyethylene (ExxonMobil). Ethylene-based copolymers are commercially available under the tradename ExxonMobil™ Polyethylene (ExxonMobil), which include metallocene produced linear low density polyethylene including Exceed™, Enable™, and Exceed™ XP.

In some embodiments, the polyethylene includes a low density, linear low density, or high density polyethylene. In some embodiments, the polyethylene can be a high melt strength (HMS) long chain branched (LCB) homopolymer polyethylene.

### 3. Butene-1-Based Polymer

Butene-1-based polymers include those solid, generally high-molecular weight isotactic butene-1 resins that primarily comprise units deriving from the polymerization of butene-1.

In some embodiments, the butene-1-based polymers include isotactic poly(butene-1) homopolymers. In some embodiments, they include copolymers copolymerized with comonomer such as ethylene, propylene, 1-butene, 1-hexane, 1-octene, 4-methyl-1-pentene, 2-methyl-1-propene, 3-methyl-1-pentene, 4-methyl-1-pentene, 5-methyl-hexene, and mixtures of two or more thereof.

In some embodiments, the butene-1-based polymer includes one or more of the following characteristics:

1) At least 90 wt % or more of the units of the butene-1-based polymer derive from the polymerization of butene-1 (such as about 95 wt % or more, such as about 98 wt % or more, such as about 99 wt % or more). In some embodiments, these polymers include homopolymers of butene-1.

2) A melt index (MI) (ASTM D-1238, 2.16 kg @ 190° C.) that is about 0.1 dg/min to 800 dg/min (such as from about 0.3 dg/min to about 200 dg/min, such as from about 0.3 dg/min to about 4.0 dg/min). In these or other embodiments, a MI of about 500 dg/min or less (such as about 100 dg/min or less, such as about 10 dg/min or less, such as about 5 dg/min or less).

3) A melt temperature (Tₘ) that is from about 130° C. to about 110° C. (such as from about 125° C. to about 115° C. such as from about 125° C. to about 120° C.).

4) A density, as determined according to ASTM D 792, that is from about 0.897 g/ml to about 0.920 g/ml, such as from about 0.910 g/ml to about 0.920 g/ml. In these or other embodiments, a density that is about 0.910 g/ml or more, such as 0.915 g/ml or more, such as about 0.917 g/ml or more.

The butene-1-based polymers may be synthesized by using an appropriate polymerization technique known in the art such as the conventional Ziegler-Natta type polymerizations, and catalysis employing single-site organometallic catalysts including metallocene catalysts. Butene-1-based polymers are commercially available. For example, isotactic poly(1-butene) is commercially available under the tradename Polybutene Resins or PB (Basell).

### Other Constituents

In some embodiments, the TPV compositions useful in polymeric inner (pressure) sheaths of flexible pipes and thermoplastic hoses may include a polymeric processing additive. The processing additive may be a polymeric resin that has a very high melt flow index. These polymeric resins include both linear and branched polymers that have a melt flow rate that is about 500 dg/min or more, such as about 750 dg/min or more, such as about 1000 dg/min or more, such as about 1200 dg/min or more, such as about 1500 dg/min or more. Mixtures of various branched or various linear polymeric processing additives, as well as mixtures of both linear and branched polymeric processing additives, can be employed. Reference to polymeric processing additives can include both linear and branched additives unless otherwise specified. Linear polymeric processing additives include polypropylene homopolymers, and branched polymeric processing additives include diene-modified polypropylene polymers. TPV compositions that include similar processing additives are disclosed in U.S. Pat. No. 6,451,915, which is incorporated herein by reference for purpose of U.S. patent practice.

In some embodiments, in addition to the rubber, thermoplastic resins, and optional processing additives, the TPV compositions of the present disclosure may optionally include reinforcing and non-reinforcing fillers, antioxidants, stabilizers, rubber processing oil, lubricants, antiblocking agents, anti-static agents, waxes, foaming agents, pigments, flame retardants, nucleating agents, and other processing aids known in the rubber compounding art. These additives can comprise up to about 50 weight percent of the total composition.

Fillers and extenders that can be utilized include conventional inorganics such as calcium carbonate, clays, silica, talc, titanium dioxide, carbon black, a nucleating agent, mica, wood flour, and the like, and blends thereof, as well as inorganic and organic nanoscopic fillers.

In some embodiments, the TPV composition may include a plasticizer such as an oil, such as a mineral oil, a synthetic oil, or a combination thereof. These oils may also be referred to as plasticizers or extenders. Mineral oils may include aromatic, naphthenic, paraffinic, and isoparafinic oils, synthetic oils, and combinations thereof. In some embodiments, the mineral oils may be treated or untreated. Useful mineral oils can be obtained under the tradename SUNPAR™ (Sun Chemicals). Others are available under the name PARALUX™ (Chevron), and PARAMOUNT™ (Chevron). Other oils that may be used include hydrocarbon oils and plasticizers, such as synthetic plasticizers. Many additive oils are derived from petroleum fractions, and have particular ASTM designations depending on whether they fall into the class of paraffinic, naphthenic, or aromatic oils. Other types of additive oils include alpha olefinic synthetic oils, such as liquid polybutylene and polyisobutylene. Additive oils other than petroleum based oils can also be used, such as oils derived from coal tar and pine tar, as well as synthetic oils, e.g., polyolefin materials. Other plasticizers include triisononyl trimellitate (TINTM).

Examples of oils include base stocks. According to the American Petroleum Institute (API) classifications, base stocks are categorized in five groups based on their saturated hydrocarbon content, sulfur level, and viscosity index (Table 4). Lube base stocks are typically produced in large scale from non-renewable petroleum sources. Group I, II, and is III base stocks are all derived from crude oil via extensive processing, such as solvent extraction, solvent or catalytic dewaxing, and hydroisomerization, hydrocracking and isodewaxing, isodewaxing and hydrofinishing [“New Lubes Plants Use State-of-the-Art Hydrodewaxing Technology” in Oil & Gas Journal, Sep. 1, 1997: Krishna et al., “Next Generation Isodewaxing and Hydrofinishing Technology for Production of High Quality Base Oils”, 2002 NPRA Lubricants and Waxes Meeting, Nov. 14-15, 2002; Gedeon and Yenni, “Use of “Clean” Paraffinic Processing Oils to Improve TPE Properties”, Presented at TPEs 2000 Philadelphia, P A., Sep. 27-28, 1999].

Group III base stocks can also be produced from synthetic hydrocarbon liquids obtained from natural gas, coal or other fossil resources, Group IV base stocks are polyalphaolefins (PAOs), and are produced by oligomerization of alpha olefins, such as 1-decene. Group V base stocks include all base stocks that do not belong to Groups I-IV, such as naphthenics, polyalkylene glycols (PAG), and esters.

TABLE 4

| API Classification | Group I | Group II | Group III | Group IV | Group V |
|---|---|---|---|---|---|
| % Saturates | <90 | ≥90 | ≥90 | Polyalpha- | All others not |
| % S | >0.03 | ≤0.03 | ≤0.03 | olefins | belonging to |
| Viscosity Index (VI) | 80-120 | 80-120 | ≥120 | (PAOs) | Groups I-IV |

In some embodiments, synthetic oils include polymers and oligomers of butenes including isobutene, 1-butene, 2-butene, butadiene, and mixtures thereof. In some embodiments, these oligomers can be characterized by a number average molecular weight (Mn) of from about 300 g/mol to about 9,000 g/mol, and in other embodiments from about 700 g/mol to about 1,300 g/mol. In some embodiments, these oligomers include isobutenyl mer units. Exemplary synthetic oils include polyisobutylene, poly(isobutylene-co-butene), and mixtures thereof. In some embodiments, synthetic oils may include polylinear α-olefins, poly-branched α-olefins, hydrogenated polyalphaolefins, and mixtures thereof.

In some embodiments, the synthetic oils include synthetic polymers or copolymers having a viscosity of about 20 cp or more, such as about 100 (cp or more, such as about 190 cp or more, where the viscosity is measured by a Brookfield viscometer according to ASTM D-4402 at 38° C. In these or other embodiments, the viscosity of these oils can be about 4,000 cp or less, such as about 1,000 cp or less.

Useful synthetic oils can be commercially obtained under the tradenames Polybutene™ (Soltex; Houston, Tex.), and Indopol™ (Ineos). White synthetic oil is available under the tradename SPECTRASYN™ (ExxonMobil), formerly SHF Fluids (Mobil), Elevast™ (ExxonMobil), and white oil produced from gas to liquid technology such as Risella™ X 415/420/430 (Shell) or Primol™ (ExxonMobil) series of white oils, e.g. Primol™ 352, Primol™ 382, Primol™ 542, or Marcol™ 82, Marcol™ 52, Drakeol® (Pencero) series of white oils, e.g. Drakeol® 34 or combinations thereof. Oils described in U.S. Pat. No. 5,936,028 may also be employed.

### Amounts

In some embodiments, the TPV compositions useful in polymeric inner (pressure) sheaths of flexible pipes and thermoplastic hoses contain a sufficient amount of the rubber to form rubbery compositions of matter. The skilled artisan will understand that rubbery compositions of matter include those that have ultimate elongations of about 100% or more, and that quickly retract to about 150% or less of their original length within about 10 minutes after being stretched to about 200% of their original length and held at about 200% of their original length for about 10 minutes.

Thus, in some embodiments, the TPV composition can include about 25 wt % or more of rubber (i.e., dynamically-vulcanized rubber), such as about 45 wt % or more, such as about 65 wt % or more, such as about 75 wt % or more, based on a combined weight of rubber and thermoplastic olefin. In these or other embodiments, the amount of rubber within the TPV composition can be from about 15 wt % to about 90 wt %, such as from about 20 wt % to about 90 wt %, such as from about 45 wt % to about 90 wt %, such as from about 45 wt % to about 85 wt %, such as from about 60 wt % to about 80 wt %, based on a combined weight of rubber and thermoplastic olefin.

In some embodiments, the amount of thermoplastic polymer or thermoplastic olefin (i.e., uncured polymer within the thermoplastic phase) within the TPV composition can be from about 10 wt % to about 85 wt % (such as from about 10 wt % to about 80 wt %, such as from about 10 wt % to about 55 wt %, such as from about 10 wt % to about 50 wt %, such as from about 10 wt % to about 40 wt %, such as from about 12 wt % to about 30 wt %) based on a combined weight of rubber and thermoplastic olefin. In these or other embodiments, the amount of thermoplastic polymer within the thermoplastic phase may be from about 25 parts by weight to about 250 parts by weight (such as from about 50 parts by weight to about 150 parts by weight, such as from about 60 parts by weight to about 100 parts by weight), per 100 parts weight rubber. In particular embodiments, the thermoplastic phase of the TPV composition of the present disclosure includes 100% butene-1-based polymer.

With respect to the thermoplastic phase, the amount of polymer present within the is phase may vary in the presence of a complementary thermoplastic resin. For example, in some embodiments, the thermoplastic phase may include from about 75 wt % to about 100 wt % butene-1-based polymer (such as from about 85 wt % to about 99 wt %, such as from about 95 wt % to about 98 wt %) based on the total weight of the thermoplastic phase, with balance of the thermoplastic phase including an ethylene-based polymer. For example, the thermoplastic phase may include from about 0 wt % to about 25 wt % an ethylene-based polymer (such as from about 1 wt % to about 15 wt %, such as from about 2 wt % to about 5 wt %) based on the total weight of the thermoplastic phase.

In these or other embodiments, where the thermoplastic phase may include a propylene-based polymer in addition to the butene-1-based polymer, the thermoplastic phase may include from about 51 wt % to about 100 wt % of butene-1-based polymer (such as from about 65 wt % to about 99.5 wt %, such as from about 85 wt % to about 99 wt %, such as from about 95 wt % to about 98 wt %) based upon the total weight of the thermoplastic phase, with balance of the thermoplastic phase including an propylene-based polymer. For example, in some embodiments, the thermoplastic phase may include from about 0 wt % to about 49 wt % of propylene-based polymer (such as from about 1 wt % to about 15 wt %, such as from about 2 wt % to about 5 wt %) based on the total weight of the thermoplastic phase.

With respect to the oil, and in some embodiments, the TPV composition may include from about 5 parts by weight to about 300 parts by weight of extender oil per 100 parts rubber (such as from about 25 parts by weight to about 250 parts by weight, such as from about 50 parts by weight to about 200 parts by weight, such as from about 50 parts by weight to about 150 parts by weight, such as from about 75 parts by weight to about 130 parts by weight). The quantity of extender oil added can depend on the properties desired, with an upper limit that may depend on the compatibility of the particular oil and blend ingredients; this limit can be exceeded when excessive exuding of extender oil occurs. The amount of extender oil can depend, at least in part, upon the type of rubber. High viscosity rubbers are more highly oil extendable.

Fillers, such as carbon black, clay, talc, or calcium carbonate or mica or wood flour or combination thereof may be added in amount from about 1 parts by weight to about 250 parts by weight of filler, per 100 parts by weight of rubber (such as about 10 parts by weight to about 250 parts by weight, such as from about 10 parts by weight to about 150 parts by weight, such as from about 25 parts by weight to about 50 parts by weight). The amount of filler (e.g., carbon black) that can be used may depend, at least in part, upon the type of carbon black and is the amount of extender oil that is used.

In some embodiments, in addition to the rubber, thermoplastic resins, and optional processing additives, the TPV composition may optionally include reinforcing and non-reinforcing fillers, colorants, antioxidants, stabilizers, rubber processing oil, lubricants, antiblocking agents, anti-static agents, waxes, foaming agents, pigments, flame retardants, antistatic agents, slip masterbatches, ultraviolet inhibitors, antioxidants, and other processing aids known in the rubber and TPV compounding art. These additives can comprise up to about 50 weight percent of the total composition.

In some embodiments, the TPV composition may include from about 10 wt % to about 85 wt % of the thermoplastic component (such as from about 15 wt % to about 70 wt/o, such as from about 20 wt % to about 50 wt %) based upon the entire weight of the TPV composition. The amount of the thermoplastic component can also be expressed with respect to the amount of the rubber component. In some embodiments, the TPV composition may include from about 20 parts by weight to about 400 parts by weight thermoplastic resin per 100 parts by weight rubber (such as from about 40 parts by weight to about 300 parts by weight, such as from about 80 parts by weight to about 200 parts by weight).

In some embodiments, the thermoplastic component includes about 0.1 wt % or more (such as about 0.25 wt % or more such as about 0.5 wt % or more, such as about 1.0 wt % or more) of the high viscosity, long-chain branched polyolefin with the remainder including the at least one other thermoplastic resin. On the other hand, the thermoplastic component includes about 5.0 wt % or less (such as about 4.75 wt % or less, such as about 4.5 wt % or less, such as about 4.0 wt % or less) of the high viscosity, long-chain branched polyolefin, with the remainder of the thermoplastic component including the at least one other thermoplastic resin.

In some embodiments, and when employed, the TPV composition may include from about 0 parts by weight to about 20 parts by weight, such as from about 1 parts by weight to about 10 parts by weight, such as from about 2 parts by weight to about 6 parts by weight of a polymeric processing additive per 100 parts by weight rubber.

### Preparation of TPV Compositions

In some embodiments, the rubber is cured or crosslinked by dynamic vulcanization. The term dynamic vulcanization refers to a vulcanization or curing process for a rubber contained in a blend with a thermoplastic resin, wherein the rubber is crosslinked or vulcanized under conditions of high shear at a temperature above the melting point of the thermoplastic. The rubber can be cured by employing a variety of curatives. Exemplary curatives include is phenolic resin cure systems, peroxide cure systems, and silicon-containing cure systems, such as hydrosilylation and silane grafting/moisture cure. Dynamic vulcanization can occur in the presence of the long-chain branched polyolefin, or the long-chain branched polyolefin can be added after dynamic vulcanization (i.e., post added), or both (i.e., some long-chain branched polyolefin can be added prior to dynamic vulcanization and some long-chain branched polyolefin can be added after dynamic vulcanization). The increase in crystallization temperature of the TPV composition of some embodiments of the present disclosure can be advantageously increased when dynamic vulcanization occurs in the presence of the high viscosity, long-chain branched polyolefin.

In some embodiments, the rubber can be simultaneously crosslinked and dispersed as fine particles within the thermoplastic matrix, although other morphologies may also exist. Dynamic vulcanization can be effected by mixing the thermoplastic elastomer components at elevated temperature in conventional mixing equipment such as roll mills, stabilizers, Banbury mixers, Brabender mixers, continuous mixers, mixing extruders and the like. Methods for preparing TPV compositions are described in U.S. Pat. Nos. 4,311,628, 4,594,390, 6,503,984, and 6,656,693, although methods employing low shear rates can also be used. Multiple-step processes can also be employed whereby ingredients, such as additional thermoplastic resin, can be added after dynamic vulcanization has been achieved as disclosed in International Application No. PCT/US04/30517.

The skilled artisan will be able to readily determine a sufficient or effective amount of vulcanizing agent to be employed without undue calculation or experimentation.

As noted above, the TPV compositions are dynamically vulcanized by a variety of methods including employing a cure system, wherein the cure system comprises a curative, such as a phenolic resin curative, a peroxide curative, a maleimide curative, a hexamethylene diamine carbamate curative, a silicon-based curative (including hydrosilylation curative, a silane-based curative such as a silane grafting followed by moisture cure), sulfur-based curative, or a combination thereof.

Useful phenolic cure systems are disclosed in U.S. Pat. Nos. 2,972,600, 3,287,440, 5,952,425 and 6,437,030.

In some embodiments, phenolic resin curatives include resole resins, which can be made by the condensation of alkyl substituted phenols or unsubstituted phenols with aldehydes, such as formaldehydes, in an alkaline medium or by condensation of bi-functional phenoldialcohols. The alkyl substituents of the alkyl substituted phenols may contain between about 1 and about 10 carbon atoms, such as dimethylolphenols or phenolic resins, substituted in para-positions with alkyl groups containing between about 1 and about 10 carbon atoms. In some embodiments, a blend of octylphenol-formaldehyde and nonylphenol-formaldehyde resins are employed. The blend includes from about 25 wt % to about 40 wt % octylphenol-formaldehyde and from about 75 wt % to about 60 wt % nonylphenol-formaldehyde, such as from about 30 wt % to about 35 wt % octylphenol-formaldehyde and from about 70 wt % to about 65 wt % nonylphenol-formaldehyde. In some embodiments, the blend includes about 33 wt % octylphenol-formaldehyde and about 67 wt % nonylphenol-formaldehyde resin, where each of the octylphenol-formaldehyde and nonylphenol-formaldehyde include methylol groups. This blend can be solubilized in paraffinic oil at about 30% solids without phase separation.

Useful phenolic resins may be obtained under the tradenames SP-1044, SP-1045 (Schenectady International; Schenectady, N.Y.), which may be referred to as alkylphenol-formaldehyde resins.

An example of a phenolic resin curative includes that defined according to the general formula

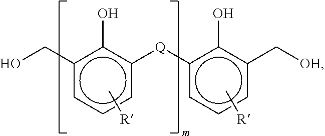

where Q is a divalent radical selected from the group consisting of —CH₂—, —CH₂—O—CH₂—; m is zero or a positive integer from 1 to 20 and R′ is an organic group. In some embodiments, Q is the divalent radical —CH₂—O—CH₂—, m is zero or a positive integer from 1 to 10, and R′ is an organic group having less than 20 carbon atoms. In other embodiments, m is zero or a positive integer from 1 to 10 and R′ is an organic radical having between 4 and 12 carbon atoms.

In some embodiments, the phenolic resin is used in combination with a halogen source, such as stannous chloride, and metal oxide or reducing compound such as zinc oxide.

In some embodiments, the phenolic resin may be employed in an amount from about 2 parts by weight to about 6 parts by weight, such as from about 3 parts by weight to about 5 parts by weight, such as from about 4 parts by weight to about 5 parts by weight per 100 parts by weight of rubber. A complementary amount of stannous chloride may include from about 0.5 parts by weight to about 2.0 parts by weight, such as from about 1.0 parts by weight to about 1.5 parts by weight, such as from about 1.2 parts by weight to about 1.3 parts by weight per 100 parts by weight of rubber. In conjunction therewith, from about 0.1 parts by weight to about 6.0 parts by weight, such as from about 1.0 parts by weight to about 5.0 parts by weight, such as from about 2.0 parts by weight to about 4.0 parts by weight of zinc oxide may be employed. In some embodiments, the olefinic rubber employed with the phenolic curatives includes diene units deriving from 5-ethylidene-2-norbornene.

In some embodiments, useful peroxide curatives include organic peroxides. Examples of organic peroxides include di-tert-butyl peroxide, dicumyl peroxide, t-butylcumyl peroxide, α,α-bis(tert-butylperoxy) diisopropyl benzene, 2,5-dimethyl-2,5-di(t-butylperoxy)hexane (DBPH), 1,1-di(tert-butylperoxy)-3,3,5-trimethyl cyclohexane, n-butyl-4-4-bis(tert-butylperoxy) valerate, benzoyl peroxide, lauroyl peroxide, dilauroyl peroxide, 2,5-dimethyl-2,5-di(tert-butylperoxy) hexyne-3, and mixtures thereof. Also, diaryl peroxides, ketone peroxides, peroxydicarbonates, peroxyesters, dialkyl peroxides, hydroperoxides, peroxyketals and mixtures thereof may be used. Useful peroxides and their methods of use in dynamic vulcanization of TPV compositions are disclosed in U.S. Pat. No. 5,656,693, which is incorporated herein by reference for purpose of U.S. patent practice.

In some embodiments, the peroxide curatives are employed in conjunction with a coagent. Examples of coagents include triallylcyanurate, triallyl isocyanurate, triallyl phosphate, sulfur, N-phenyl bis-maleamide, zinc diacrylate, zinc dimethacrylate, divinyl benzene, 1,2-polybutadiene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, and oximes such as quinone dioxime. In order to maximize the efficiency of peroxide/coagent crosslinking the mixing and dynamic vulcanization may be carried out in a nitrogen atmosphere.

In some embodiments, silicon-containing cure systems may include silicon hydride compounds having at least two Si—H groups. Silicon hydride compounds that are useful in practicing the present disclosure include methylhydrogenpolysiloxanes, methylhydrogendimethylsiloxane copolymers, alkylmethyl-co-methylhydrogenpolysiloxanes, bis(dimethylsilyl)alkanes, bis(dimethylsilyl)benzene, and mixtures thereof.

Useful catalysts for hydrosilylation include transition metals of Group VIII. These metals include palladium, rhodium, and platinum, as well as complexes of these metals. Useful silicon-containing curatives and cure systems are disclosed in U.S. Pat. Nos. 5,936,028, 4,803,244, 5,672,660, and 7,951,871.

In some embodiments, the silane-containing compounds may be employed in an is amount from about 0.5 parts by weight to about 5.0 parts by weight per 100 parts by weight of rubber (such as from about 1.0 parts by weight to about 4.0 parts by weight, such as from about 2.0 parts by weight to about 3.0 parts by weight). A complementary amount of catalyst may include from about 0.5 parts of metal to about 20.0 parts of metal per million parts by weight of the rubber (such as from about 1.0 parts of metal to about 5.0 parts of metal, such as from about 1.0 parts of metal to about 2.0 parts of metal). In some embodiments, the olefinic rubber employed with the hydrosilylation curatives includes diene units deriving from 5-vinyl-2-norbornene.

The skilled artisan will be able to readily determine a sufficient or effective amount of vulcanizing agent to be employed without undue calculation or experimentation.

For example, a phenolic resin can be employed in an amount of about 2 parts by weight to about 10 parts by weight per 100 parts by weight rubber (such as from about 3.5 parts by weight to about 7.5 parts by weight, such as from about 5 parts by weight to about 6 parts by weight). In some embodiments, the phenolic resin can be employed in conjunction with stannous chloride and optionally zinc oxide. The stannous chloride can be employed in an amount from about 0.2 parts by weight to about 10 parts by weight per 100 parts by weight rubber (such as from about 0.3 parts by weight to about 5 parts by weight, such as from about 0.5 parts by weight to about 3 parts by weight). The zinc oxide can be employed in an amount from about 0.25 parts by weight to about 5 parts by weight per 100 parts by weight rubber (such as from about 0.5 parts by weight to about 3 parts by weight, such as from about 1 parts by weight to about 2 parts by weight).

Alternately, in some embodiments, a peroxide can be employed in an amount from about 1×10⁻⁵ moles to about 1×10⁻¹ moles, such as from about 1×10⁻⁴ moles to about 9×10⁻² moles, such as from about 1×10⁻² moles to about 4×10⁻² moles per 100 parts by weight rubber. The amount may also be expressed as a weight per 100 parts by weight rubber. This amount, however, may vary depending on the curative employed. For example, where 4,4-bis(tert-butyl peroxy) diisopropyl benzene is employed, the amount employed may include from about 0.5 parts by weight to about 12 parts by weight, such as from about 1 parts by weight to about 6 parts by weight per 100 parts by weight rubber. The skilled artisan will be able to readily determine a sufficient or effective amount of coagent that can be used with the peroxide without undue calculation or experimentation. In some embodiments, the amount of coagent employed is similar in terms of moles to the number of moles of curative employed. The amount of coagent may also be expressed as weight per 100 parts by weight rubber. For example, where the triallylcyanurate coagent is employed, the amount employed can include from about 0.25 phr to about 20 phr, such as from about 0.5 phr to about 10 phr, based on 100 parts by weight rubber.

### EXPERIMENTAL

Ultimate tensile strength (“UTS”), modulus at 100% extension (“M100”), and ultimate elongation (“UE”) were measured on injection molded plaques according to ASTM D-412 at 23° C. (unless otherwise specified) at 50 mm per minute by using an Instron testing machine.

The weight gain % was measured according to ASTM D471 for 24 h and at 121° C. using IRM903 oil. Without being bound by theory, it is believed that negative weight gain indicates a removal of extractable components (e.g., oil) from the TPV composition, and a positive weight gain indicates an absorption of oil into the TPV composition.

Permeability was measured according to ASTM D1434-82, Procedure V. Permeability is measured in units of barrers. The films are tested at 23° C. using a gas pressure of 30-40 psi.

Gas permeability data of exemplary TPV compositions are provided in Tables 1-3.

Example 1 is a butyl rubber based TPV composition, a polypropylene thermoplastic phase, and a polyisobutylene plasticizer previously sold by ExxonMobil as TREFSIN™ 3201-65. Examples 2 and 3 are TPV compositions having a nitrile butadiene rubber phase and a polypropylene thermoplastic phase previously sold by ExxonMobil as GEOLAST™ 701-87 and 703-50, respectively. Comparative examples CEx1, CEx2, CEx3 and CEx4 are TPV compositions having an ethylene propylene rubber phase and polypropylene thermoplastic phase. All TPV compositions that are inventive and comparative are available commercially from ExxonMobil. Comparative example CEx5 is a commercially available polyamide-11 (PA11) available under the tradename Rilsan™ from Arkema.

TABLE 1
List of Comparative and Inventive Samples

| | Formulation/Commercial | |
|---|---|---|
| Sample | Name | Supplier |
| Ex1 | Trefsin 3201-65W305 | ExxonMobil |
| Ex2 | Geolast 701-87 | ExxonMobil |
| Ex3 | Geolast 703-50 | ExxonMobil |
| CEx1 | Santoprene 201-64 | ExxonMobil |
| CEx2 | Santoprene 201-73 | ExxonMobil |
| CEx3 | Santoprene 201-87 | ExxonMobil |
| CEx4 | Santoprene 203-50 | ExxonMobil |
| CEx5 | PA11 Rilsan | Arkema |
| Ex9 | Santoprene 201-64 | ExxonMobil |
| Ex10 | Santoprene 8201-60 | ExxonMobil |
| Ex11 | Geolast 701-70 | ExxonMobil |
| Ex12 | Trefsin 3201-65W305 | ExxonMobil |
| Ex13 | Santoprene 101-87 | ExxonMobil |
| Ex14 | Santoprene 203-50 | ExxonMobil |
| Ex15 | Santiorene 8201-90 | ExxonMobil |
| Ex16 | Geolast 701-70 | ExxonMobil |
| Ex17 | Geolast 701-87W183 | ExxonMobil |
| Ex18 | Santoprene 101-87A | ExxonMobil |
| Ex19 | Neoprene Thermoset | Various |
| Ex20 | Nitrile Thermoset | Various |
| Ex21 | Geolast 701-80 | ExxonMobil |
| Ex22 | Geolast 703-40 | ExxonMobil |
| Ex23 | Santoprene 101-87A | ExxonMobil |
| Ex24 | Santoprene 203-50D | ExxonMobil |
| Ex25 | PA 11 Rilsan | Arkema |

TABLE 2
Permeability of TPV Compositions

| | Permeability (barrers) | | | | | | | |
|---|---|---|---|---|---|---|---|---|
| | Ex1 | Ex2 | Ex3 | CEx1 | CEx2 | CEx3 | CEx4 | CEx5 |
| Air | 1.0 | 2.3 | 1.4 | 11.8 | 16.0 | 20.1 | 9.3 | — |
| CO₂ | 2.5 | 29.9 | 30.0 | 50.0 | 13.0 | 8.6 | 5.7 | 1.1 |

The data in the Tables show that, in terms of permeability, the TPV composition having a butyl rubber (e.g., Example 1) shows the lowest air permeability compared to TPV compositions with PP/EPDM, e.g., CEx1-4. More specifically, the TPV composition having butyl rubber such as paramethylstyrene butyl rubber and polyisobutylene plasticizer (e.g., (Example 1) showed lowest permeability. Having low permeability to gas is advantageous for use as inner (pressure) layer/sheath. The TPV compositions having a nitrile rubber (e.g., Ex2 and Ex3) shows significantly lower air permeability compared to comparative examples CEx1-CEx4. Advantageously, the permeability of the inventive TPV compositions are comparable to PA11 while showing superior flexibility and lower cost.

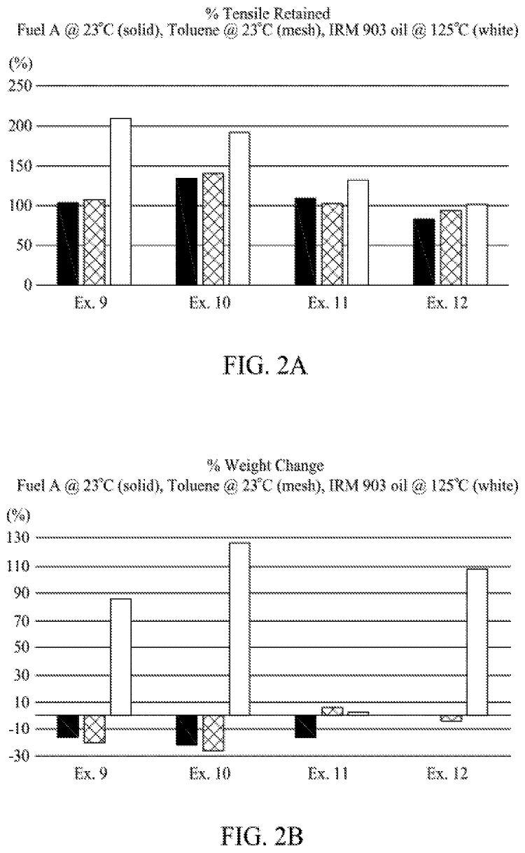

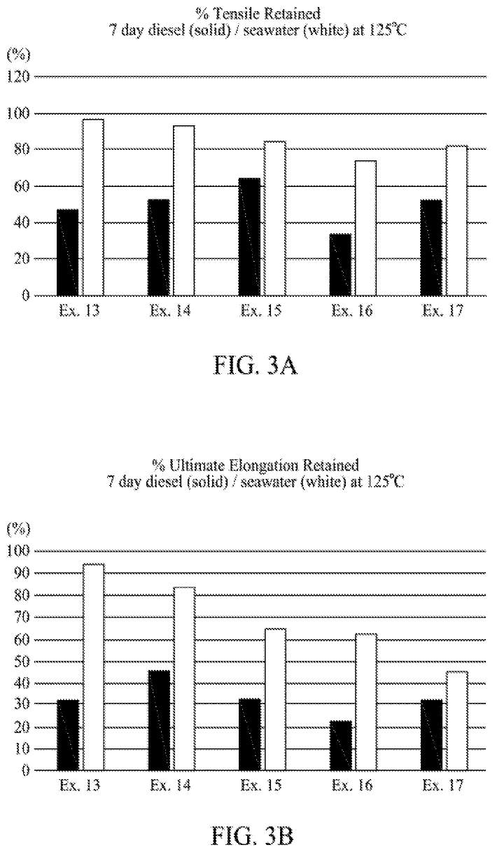

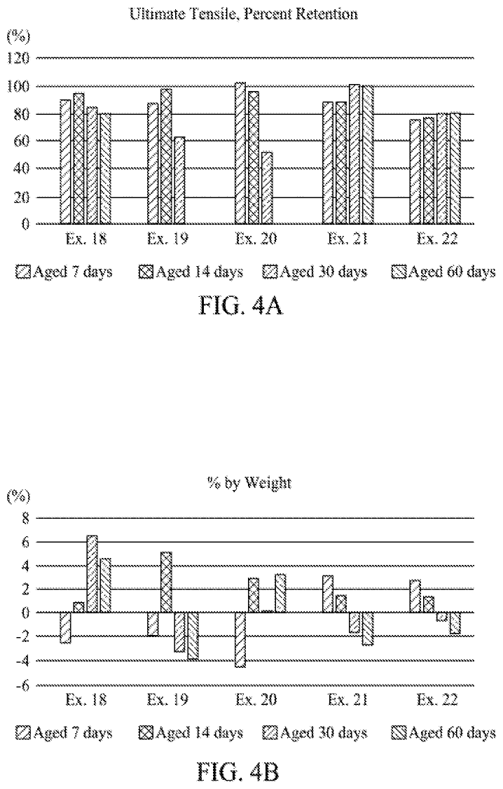

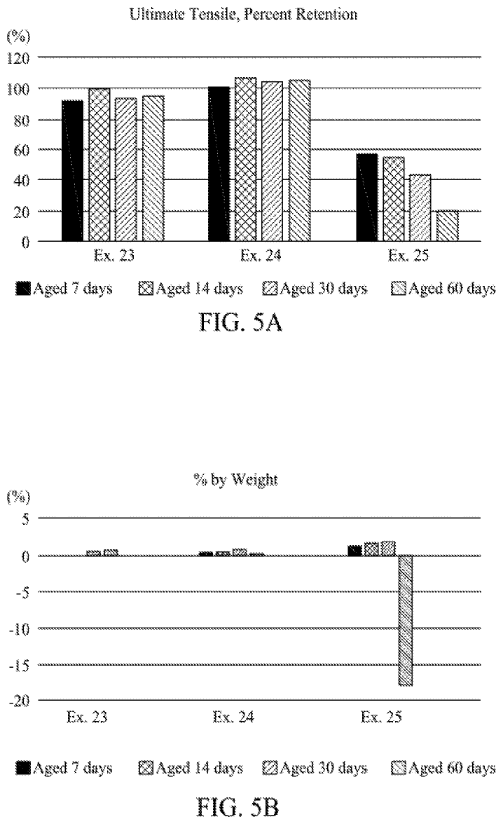

Fluid stability data of exemplary TPV compositions are provided as bar graphs in FIGS. 2A-2B, 3A-3B, 4A-4B, and 5A-5B. Examples 9, 10, 13, 14, 15, 18, and 23 are TPV compositions having an ethylene-propylene rubber phase. Examples 11, 16, 17, 21, and 22 are TPV compositions having a nitrile butadiene rubber phase. Example 12 is a TPV composition having a butyl rubber phase and a polyisobutylene plasticizer. Example 24 is a 50D EP TPV composition. Example 19 is a neoprene thermoset, Example 20 is a nitrile thermoset, and Example 25 is Nylon PA11.

The following trends are illustrated by the bar graphs of FIGS. 2-5. In terms of fluid resistance and chemical resistance, TPV compositions with nitrile rubber (Examples 11, 16, 17, 21, and 22) performed well, showing a low swell volume change. For example, nitrile rubber based TPV compositions performed better than EPDM rubber based and butyl rubber based TPV compositions. Regarding strength change of the TPV compositions w % ben exposed to different fluids, nitrile based rubber and EPDM rubber based TPV compositions performed better than butyl based TPV compositions. Having good chemical resistance is advantageous for, e.g., the inner (pressure) layer/sheath. Each TPV composition performed better than a nylon composition.

The data in the Tables and the FIGS. reveal that, advantageously, the TPV compositions disclosed herein are useful materials for polymeric inner (pressure) sheaths in flexible pipes. The TPV compositions exhibit low gas permeability in gases such as air and CO₂, and have excellent thermal stability in different fluids such as diesel, seawater, and chemicals.

The TPV compositions described herein provide an alternative and more robust material for polymeric inner (pressure) sheaths in flexible pipes and hoses for fluid containment. Pressure sheaths should have good fluid resistance and low permeability. The examples illustrated herein show that TPV compositions have good fluid resistance and low permeability at an advantageous cost. Moreover, the TPV compositions performed better than conventional nylon compositions particularly in flexibility.

Thus, the TPV compositions described herein can be used in polymeric inner (pressure) sheaths of flexible pipes or in thermoplastic hoses for oil and gas field applications. The TPV compositions advantageously provide better stability in chemicals and fluids than conventional nylons used for polymer inner (pressure) sheaths in flexible pipes and hoses. The TPV compositions are more resistant to hydrolysis, have little to no plasticizer migration, and have low permeability to various gases. Such TPV compositions, therefore, advantageously provide for better polymeric inner (pressure) sheaths for the transport of various fluids, gases, and equipment in the harsh environments of offshore and onshore oil and gas applications.

All documents described herein are incorporated by reference herein, including any priority documents and/or testing procedures to the extent they are not inconsistent with this text. As is apparent from the foregoing general description and the specific embodiments, while forms of the embodiments have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “I” preceding the recitation of the composition, element, or elements and vice versa, e.g., the terms “comprising,” “consisting essentially of,” “consisting of” also include the product of the combinations of elements listed after the term.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present disclosure. Further, all documents and references cited herein, including testing procedures, publications, patents, journal articles, etc. are herein fully incorporated by reference for all jurisdictions in which such incorporation is permitted and to the extent such disclosure is consistent with the description of the present disclosure.

While the present disclosure has been described with respect to a number of embodiments and examples, those skilled in the art, having benefit of the present disclosure, will appreciate that other embodiments can be devised which do not depart from the scope and spirit of the present disclosure as described herein.

1. A flexible pipe comprising:
a polymeric inner sheath that comprises a thermoplastic vulcanizate (TPV) composition, the TPV composition comprising:
a rubber and a thermoplastic olefin, wherein
a concentration of the rubber is from 20 wt % to 90 wt % based on a combined weight of the rubber and the thermoplastic olefin, and a concentration of the thermoplastic olefin is from 10 wt % to 80 wt % based on the combined weight of the rubber and the thermoplastic olefin; and
wherein the TPV composition has at least one of an air permeability of less than 30 barrers at 23° C. and a CO₂ permeability of less than 40 barrers at 23° C.

2. The flexible pipe of claim 1, wherein the TPV composition has a percent tensile retention when exposed to seawater at 125° C. for seven days of 60% or more.

3. The flexible pipe of claim 1, wherein the TPV composition has a percent elongation retention when exposed to seawater at 125° C. for seven days of 40% or more.

4. The flexible pipe of claim 1, wherein the TPV composition has a percent weight change (wt %) in an aqueous solution of 18% calcium chloride and 14% calcium bromide (125° C., aged 60 days) of from about −5 to about +5.

5. The flexible pipe of claim 1, wherein the TPV composition has a hardness of from 60 Shore A to 60 Shore D (ASTM D2240).

6. The flexible pipe of claim 1, wherein the TPV composition further comprises a plasticizer.

7. The flexible pipe of claim 6, wherein the plasticizer is selected from the group consisting of paraffinic oil, polyisobutylene, synthetic oil, triisononyl trimellitate, and a combination thereof.

8. The flexible pipe of claim 1, wherein the TPV composition further comprises at least one of a filler and a nucleating agent.

9. The flexible pipe of claim 1, wherein the TPV composition further comprises a cure system.

10. The flexible pipe of claim 9, wherein the cure system comprises a phenolic resin, a peroxide, a maleimide, a hexamethylene diamine carbamate, a silicon-based curative, a silane-based curative, a sulfur-based curative, or a combination thereof.

11. The flexible pipe of claim 9, wherein the cure system includes at least one of a hydrosilylation curative and a phenolic resin curative.

12. The flexible pipe of claim 1, wherein the TPV composition further comprises calcium carbonate, clay, silica, talc, titanium dioxide, carbon black, mica, wood flour, or a combination thereof.

13. The flexible pipe of claim 1, wherein the rubber has a Mw of from 100,000 g/mol to 3,000,000 g/mol.

14. The flexible pipe of claim 1, wherein the rubber is one or more of a nitrile rubber and a butyl rubber.

15. The flexible pipe of claim 1, wherein the rubber is a nitrile rubber comprising 1,3-butadiene or isoprene and acrylonitrile.

16. The flexible pipe of claim 15, wherein the rubber has an acrylonitrile-derived content that is from 20 wt % to 50 wt % based on a total weight of a nitrile based rubber.

17. The flexible pipe of claim 1, wherein the rubber is a butyl rubber selected from the group consisting of isobutylene-isoprene rubber (IR), brominated isobutylene-isoprene rubber (BIIR), and isobutylene paramethyl styrene rubber (BIMSM).

18. The flexible pipe of claim 17, wherein the butyl rubber is an isobutylene-paramethylstyrene rubber comprising from 0.5 wt % to 25 wt % paramethylstyrene based on an entire weight of the rubber.

19. The flexible pipe of claim 17, wherein the butyl rubber is an isobutylene-isoprene rubber comprising from 0.5 wt % to 30 wt % isoprene based on an entire weight of the rubber.

20. The flexible pipe of claim 17, wherein the butyl rubber is a brominated isobutylene-isoprene rubber comprising a percent by weight halogenation of from 0.3 wt % to 7 wt % based on an entire weight of the rubber.

21. The flexible pipe of claim 1, wherein the thermoplastic olefin is one or more of a polypropylene, a polyethylene, and a polybutene-1.

22. A pipe structure, comprising:
the flexible pipe of claim 1, wherein the pipe structure is in accordance with at least one of the following standards API Spec 17J, API Spec 17K, and DNV RP F119.

23. The flexible pipe of any of claim 1, wherein the polymeric inner sheath has a thickness of from 0.5 mm to 50 mm.

24. The flexible pipe of claim 1, further comprising:
an inner housing;
at least one reinforcing layer at least partially disposed around the inner housing; and
an outer protective sheath at least partially disposed around the at least one reinforcing layer.

25-45. (canceled)
